(19) United States
(12) Patent Application Publication
(10) Pub. No.: US 2014/0072373 A1
(43) Pub. Date: Mar. 13, 2014

(54) Method and Apparatus for Treatment of Contaminated Soil and Sediment

(71) Applicant: Robert D. Mutch, Ramsey, NJ (US)

(72) Inventor: Robert D. Mutch, Ramsey, NJ (US)

(21) Appl. No.: 13/608,489

(22) Filed: Sep. 10, 2012

(51) Int. Cl. E02D 3/12; B09C 1/00

(52) U.S. Cl. 405/263

(57) ABSTRACT

A treatment slurry is emplaced in soil in columns formed by displacement of soil by a direct push rod, a vibrating beam, or otherwise. The treatment slurry is pumped into the impression created as the rod or vibrating beam is withdrawn from the subsurface, creating a vertical column in the subsurface with a cross-sectional shape of the rod or vibrating beam that is filled with the treatment slurry. The vertical columns are spaced at suitable distances to allow for diffusion of a treatment agent in the treatment slurry into the surrounding soils or sediments to treat the target contaminants in the subsurface soils or sediments.

### BACKGROUND OF THE INVENTION

1. Field of the Invention

The present invention relates generally to a method and apparatus for treatment of contaminated soil and sediment.

2. Related Art

There have been many efforts in the past directed to in situ treatment of contamination in subsurface soil in both the unsaturated zone and the saturated zone. Many of these efforts involve pumping liquid treatment agents into the subsurface through wells or injection trenches, or other means, to treat targeted contaminants by in situ chemical oxidation, in situ chemical reduction, or by promoting biologically-mediated transformations. In such efforts, the liquid treatment agents have been induced to flow from the well or injection trench through the subsurface by advection and dispersion to reach the targeted contaminants of concern. The necessity of the treatment agents to be able to flow from the point of injection into the subsurface at reasonably rapid rates has dictated that these methods are particularly suitable to aquifers and other geologic formations with sufficiently high hydraulic conductivity to permit significant advective flow. These advection-based methodologies struggle or are infeasible in aquitards and lower hydraulic conductivity geologic formations to induce significant flow of treatment agents. This has become a problem as it has become increasingly known that diffusion and slow advective transport, often over many decades, has led to considerable contamination migration into lower permeability aquitards. The contamination within such aquitards can serve as long-lived sources of contamination to surrounding aquifers as it slowly migrates back out through diffusion and slow advection over decades and even centuries. Many contaminant source areas are found within low permeability aquitards which can limit application of conventional in situ treatment methods relying on advective transport of treatment agents.

There are technologies that are better suited for low permeability aquitards. These technologies include excavation, in situ soil mixing, thermal treatment (for some contaminants), and hydraulic fracturing. However, all these technologies have their limitations and some are quite expensive. What is needed is an approach that addresses these deficiencies.

### SUMMARY OF THE INVENTION

The present disclosure relates to a method and apparatus for treatment of contaminated soil in either the unsaturated or saturated zone. A treatment slurry is emplaced into subsurface soil, in the form of vertical columns. The columns are formed by the direct push of a rod into the soil, by vibrating a beam into the soil, or otherwise. The rod or vibrating beam is used to displace the native soil or sediment to the desired depth, and then the treatment slurry is pumped into the impression created as the rod or vibrating beam is withdrawn from the subsurface. Consequently, a vertical column is created in the subsurface having the cross-sectional shape of the rod or vibrating beam that has been filled with the treatment slurry. The treatment slurry includes a self-hardening slurry component and a treatment agent. The vertical columns are spaced at suitable distances to allow for diffusion of the treatment agent into the surrounding soils or sediments to treat target contaminants in the subsurface soils.

### BRIEF DESCRIPTION OF THE DRAWINGS

The foregoing features of the invention will be apparent from the following Detailed Description of the Invention, taken in connection with the accompanying drawings, in which:

FIG. 1 is a schematic view the apparatus for treatment of contaminated soil;

FIG. 2 is a schematic view of the apparatus showing a beam placed into soil;

FIG. 3 is schematic view of the apparatus showing a treatment slurry being emplaced in soil and the beam being withdrawn;

FIG. 4 is schematic view of the apparatus showing the beam removed and the treatment slurry fully emplaced in soil;

FIG. 5 is a top view of an array of H-beam impressions;

FIG. 6 is a top view of an array of circular impressions;

FIG. 7 is a schematic view showing a treatment slurry selectively targeted to a deeper interval in the subsurface within the columns and an inert covering slurry placed within the columns above the target zone;

FIG. 8 is a schematic view showing emplacement of beams and treatment slurry at an angle in soil; and

FIG. 9 is a schematic view of the apparatus on a barge for the purpose of emplacement of treatment slurry into contaminated sediments under water.

### DETAILED DESCRIPTION OF THE INVENTION

The methods and apparatus disclosed herein relate to the formation of columnar impressions in soil by displacement of the soil and the emplacement of a treatment slurry in the columns. The treatment agent diffuses out of the treatment slurry over time into the surrounding soil to treat contamination in the surrounding soil.

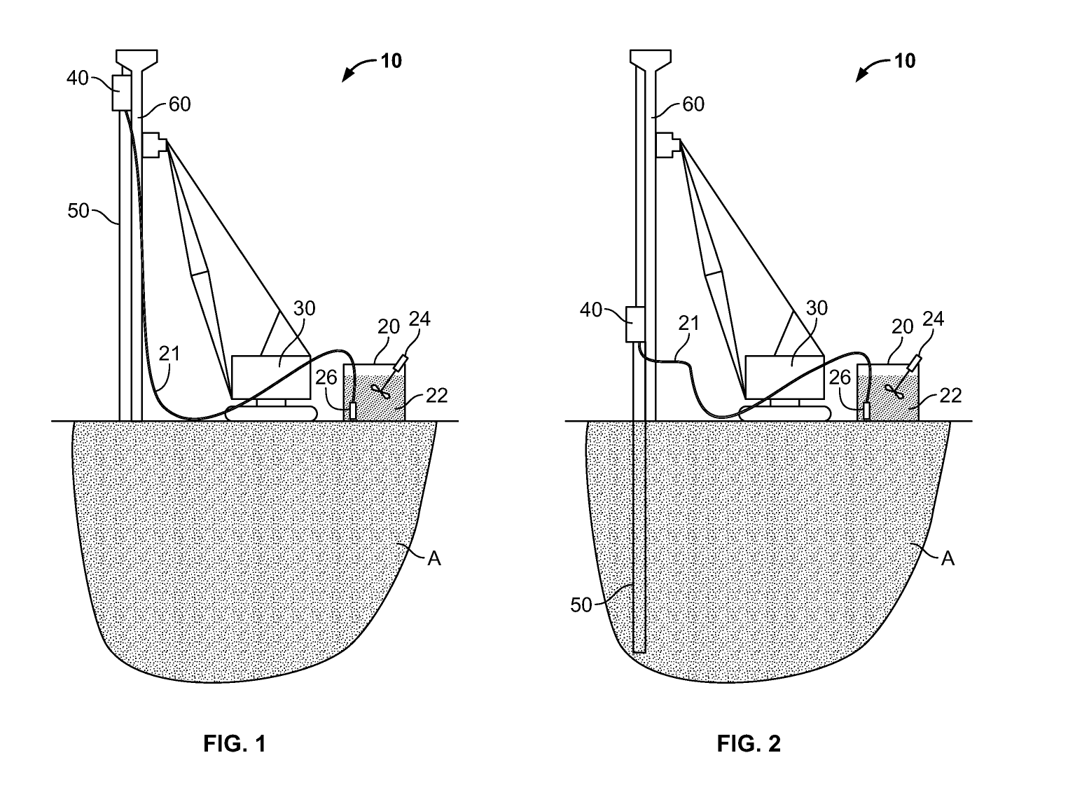

FIG. 1 shows the components of the apparatus, generally indicated at 10, for treatment of contaminated soil. A tank 20 is provided for holding a treatment slurry 22. The treatment slurry treatment 22 could be formed from a mixture of a self-hardening slurry component and a treatment agent as will be discussed. The tank 20 can be positioned on the surface of soil, or alone or with other components, can be placed on a vehicle or rig or other support structure that can be mobile. A mixer 24 can be used to stir the treatment slurry 22 to keep it well-mixed and in a flowable, pumpable state. A pump 26 is provided to pump the treatment slurry 22 from the tank 20 through line 21 to a subsurface location where it will be emplaced as will be discussed in greater detail below. The tank 20 can be made of any suitable material and can be of any suitable shape and can be sized in accordance with the amount of treatment slurry to be used in a given treatment area A.

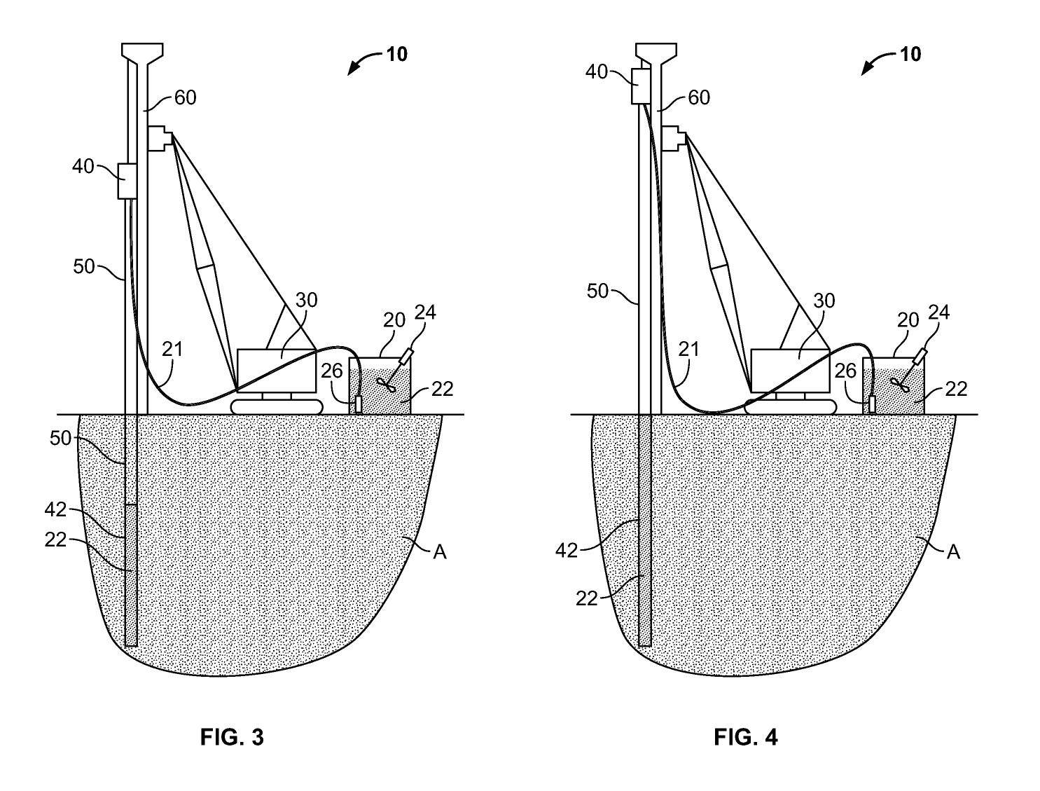

A vibrating beam rig 30 is provided on the surface of the soil for creating, along with other components, a columnar impression 42 (see FIG. 3) in the soil. The vibrating beam rig 30 could be mobile or positioned on a mobile platform. The vibrating beam rig 30 is interconnected with and drives vibrating (vibratory) hammer 40, which is positioned at an end of a vertically-placed beam such as a beam 50 having an H-shape in cross-section or other beam or rod with another cross-section. A guide beam 60 is positioned to align and guide the beam 50 as it is vibrated into the subsurface of the soil by the vibrating hammer 40. Other mechanisms for the displacement or movement of soil, without removal of the soil, could be used to create a columnar impression 42 in the soil. For example, a push rod could be pushed into the soil or another structure could be hammered into the soil. Examples of such devices include direct push rigs manufactured and sold by Geoprobe Systems in Salina, Kans., or HydroPunch rigs. These direct push drilling rigs advance a small-diameter rod of circular cross-section into the subsurface using the weight of the rig and a percussion hammer as needed. In the past, vibrating beam rigs have been used to make impressions along a line, or chain, and the impressions have been filled with inert slurries (without a treatment agent) to create low permeability barrier walls in dikes or around landfills. The push rod typically has a plurality of sections and each section is relatively short (i.e. 3 to 5 feet). The rod sections are connected together to advance the direct push rod to a targeted depth. It should be noted that any other type of soil movement equipment, or even soil excavation equipment including, for example, a drill, an auger, a coring tool, a digging tool, etc., could be used to create a space in the soil for emplacement of the treatment slurry.

A columnar impression 42 of a rod or H-beam is created in the subsurface as shown in FIGS. 2-4, using in this illustrative example, the vibrating beam rig 30 and vibrating hammer 40. Once the vibrating beam rig 30 is set-up in the correct position, the H-beam 50 is driven into the subsurface to the desired depth as shown in FIG. 2. The H-beam 50 can then be withdrawn and the treatment slurry 22 can be pumped from the tank 20 into the impression 42 formed by the H-beam 50. The treatment slurry 22 can be pumped into the impression 42 formed by the H-beam 50 as the H-beam 50 is removed from the soil. For example, the treatment slurry 22 could be pumped through a pipe attached to the side of the beam 50, by welding or otherwise, to fill the impression 42 in the subsurface created by the H-beam, as shown in FIG. 3. Alternately, the treatment slurry could be pumped through the interior of the rods of a direct push device. This process continues until the beam is fully withdrawn from the subsurface, as shown in FIG. 4, leaving the columnar impression 42 of the beam 50 in the subsurface filled with the treatment slurry 22. The vibrating beam rig 30 can then move to another location, which could be pre-set, and process can be repeated to create a number of columnar H-beam impressions in a desired array, filled with the treatment slurry.

The columns could be created by directly pushing a rod or some other structure into the soil, by vibrating a beam into the soil, by a percussion method to percuss or hammer a structure into the soil, or by a sonic method that sonically moves a structure into the soil, or by another method. The rod, beam or other structure forms a column in the soil. Removal of the rod, beam or other structure leaves an empty column in the soil. The impressions created could be circular or have other shapes. If an H-beam is used, the column would take on the cross-section shape of an H. Other cross sectional shapes could also be made and different shapes could be used for different applications including circles (as are commonly used in direct push drilling), squares, crosses, rectangles, pentagons, and hexagons.

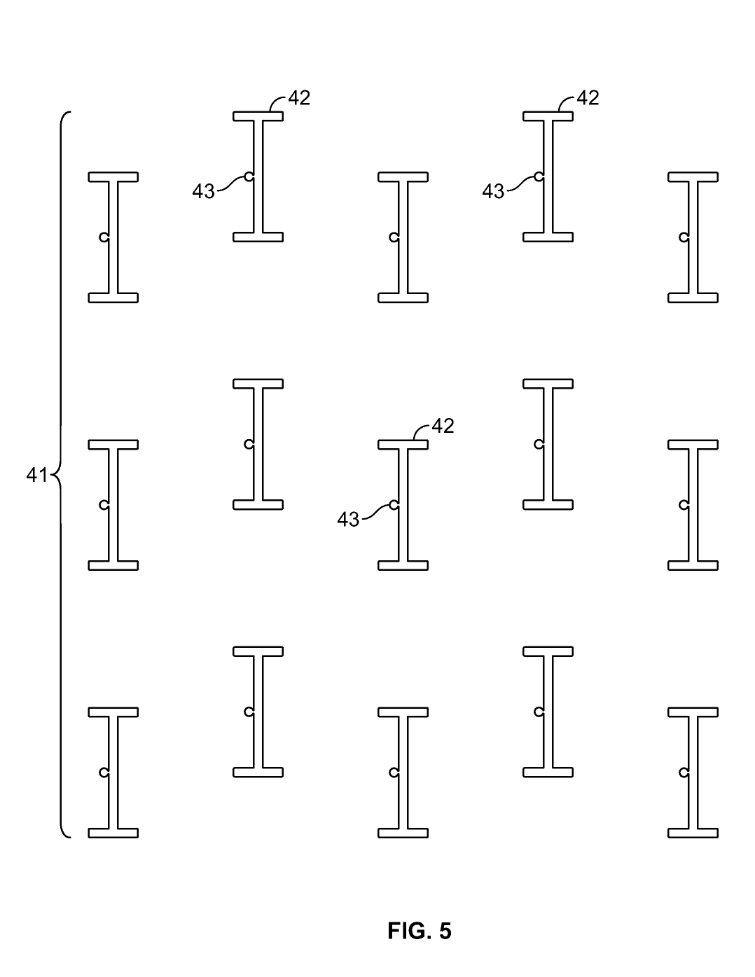

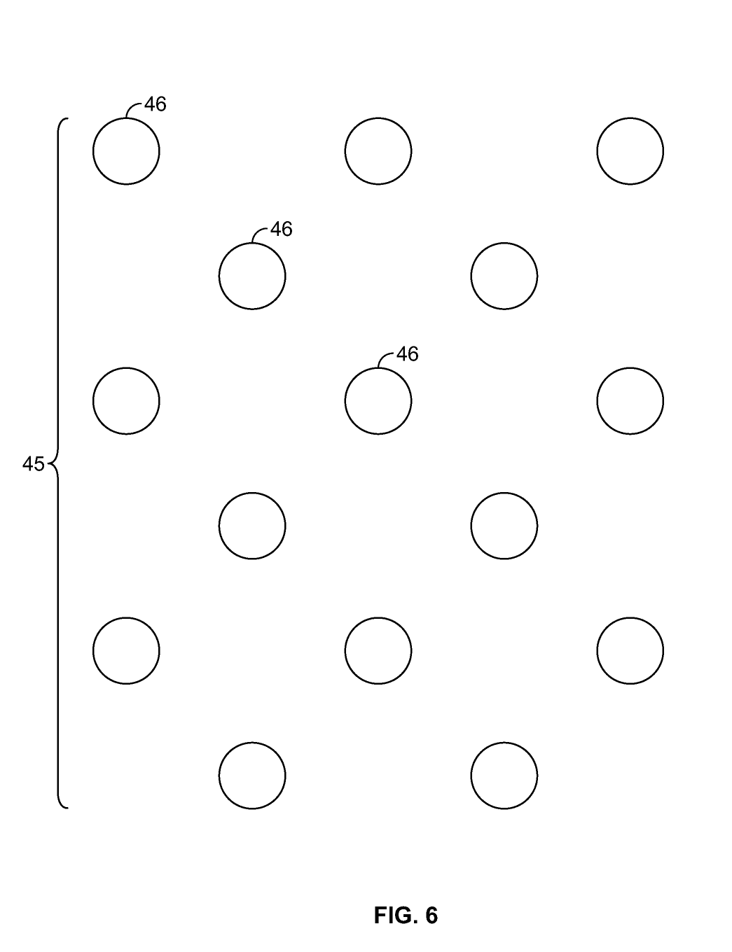

A top view of an example of a pattern or array 41 of H-beam columns 42 is shown in FIG. 5. A pipe can be attached to the H-beam for delivery of the treatment slurry or an inert covering slurry. The pipe creates impression 43 alongside the H-beam impression. Not shown in the diagram is the keying element or “fin” normally used to key one beam impression into the next when the vibrating beam technology is being used for constructing subsurface barrier walls. The keying element is optional in this application. An example of a pattern or array 45 of circular columns 46 is shown in FIG. 6. The slurry can be delivered into the circular column impression through an aperture in the rod used to create the impression. The vertical columns in the subsurface are made by moving or displacing soil.

The vertical columns, filled with the treatment slurry could be spaced at different distances and in different patterns to promote diffusive transport of the treatment agent into the surrounding soils or sediments in amounts and in the timeframe desired. The composition of the treatment slurry can include an amount of bentonite, cement, water, treatment agent, and other components which can be varied as necessary to achieve the desired concentration of active treatment agent and to have the physical properties needed to be pumped and emplaced in the subsurface and to achieve any long-term physical properties that may be required in certain applications. The cement component can be added just prior to emplacement to avoid hardening of the treatment slurry before emplacement. The treatment slurry pumped into the vertical core produced by the above-described rigs could include a mixture of a self-hardening slurry component and a variety of potential treatment agents. The self-hardening slurry component could include bentonite-cement mixtures, or other similar products capable of producing a pumpable slurry suitable for mixing with the treatment agent of choice that would subsequently harden in the subsurface after emplacement. For example, the treatment slurry could have a viscosity of approximately 15 centipoise when it is pumped into the soil. A typical mix could comprise approximately six percent (6%) by weight bentonite, ten percent (10%) by weight Portland cement, and eightyfour percent (84%) by weight water. A chemical treatment agent of choice can dissolved in the water or added as particles in suspension to the thick viscous slurry. If cement is added, over time, the treatment slurry will solidify to a denser state, e.g. to a semi-solid state having a consistency similar to the consistency of soil. If cement is not added, the treatment slurry will remain at 15 centipose.

The treatment agent could include of a variety of chemicals depending upon the target contaminants in the subsurface. The treatment agents could include chemical oxidants, chemical reductants, or agents to promote aerobic or anaerobic bioremediation. A list of example target contaminants and treatment agents is included in Table 1. The treatment agent could be combined with the self-hardening slurry component as either a dissolved species in water or as solid particles suspended within the self-hardening slurry component. For example, particles of sodium permanganate or potassium permanganate could be suspended within the self-hardening slurry component to increase the amount of permanganate contained in the treatment slurry columnar beam impressions.

TABLE 1
Example Applications of Method and Apparatus
for Treatment of Contaminated Soil and Sediments

| Category of In Situ | | Example Target |
|---|---|---|
| Treatment | Example Treatment Agents | Contaminants of Concern |
| In Situ Chemical | Potassium permanganate, sodium | Coal tar, polyaromatic |
| Oxidation | permanganate, sodium persulfate, sodium | hydrocarbons, creosote, |
| | percarbonate, calcium peroxide | chlorinated ethenes (i.e. |
| | | tetrachloroethylene, |
| | | trichloroethylene, |
| | | dichloroethylene, vinyl |
| | | chloride), chlorinated |
| | | aromatics (i.e. |
| | | pentachlorophenol, mono-, |
| | | di-, tri- and |
| | | tetrachlorophenols), |
| | | explosives, energetics, and |
| | | breakdown products (i.e. |
| | | hexahydro-1,3,5-trinitro- |
| | | 1,3,5-triazine (RDX), |
| | | cctahydro-1,3,5,7-tetranitro- |
| | | 1,3,5,7-tetrazocine (HMX), |
| | | mono- and dinitrophenols), |
| | | 1,4-dioxane, MTBE (methyl |
| | | tert-butyl ether), BTEX |
| | | (benzene, toluene, |
| | | ethylbenzene, xylenes) |
| In Situ Chemical | Calcium polysulfide, sodium dithionite, | Hexavalent chromium, |
| Reduction | sodium metabisulfite, calcium | mercury |
| | metabisulfite, ferrous sulfate, sodium | |
| | thiosulfate | |
| In Situ BioTreatment | Slow release oxygen compounds, hydrogen | Petroleum products (i.e. fuel |
| | peroxide, organic substrates | oil, gasoline, jet fuel, BTEX), |
| | | chlorinated ethenes and |
| | | chlorinated ethanes, |
| | | chloroform, carbon |
| | | tetrachloride |

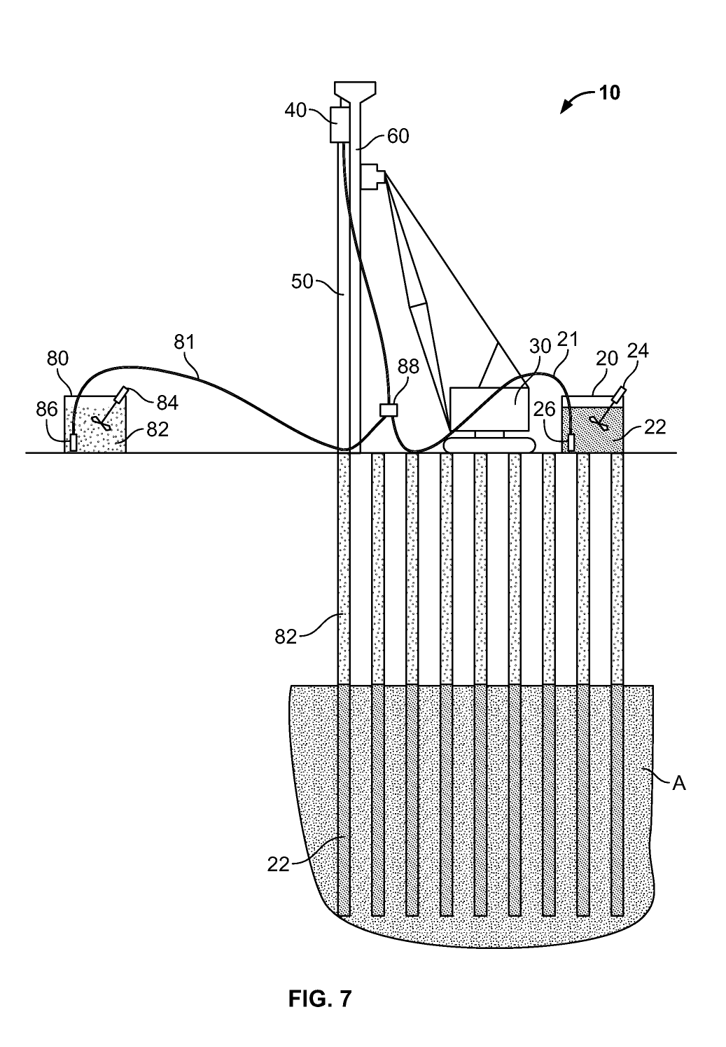

The methods and apparatus disclosed herein could also be employed to treat contamination in target zones where the contamination is at a depth in the subsurface that is below clean soil, without necessarily emplacing treatment slurry in overlying uncontaminated soil. This could be accomplished using two different slurries (contained in different tanks, for example): one being a treatment slurry having a treatment agent, and one being an inert self-hardening covering slurry. Referring to FIG. 7, one tank 20 having a treatment slurry 22, a mixer 24 and pump 26, and a second tank 80 having an inert covering slurry (without treatment agent) 82 and a mixer 84 and a pump 86, could use lines 21 and 81, respectively, to deliver the respective compositions to valve 88. A columnar impression is formed in the soil by an H-beam 50 vibrating beam rig 30, vibration hammer 40 and guide beam 60. Valve 88 can then be used to alternately direct the treatment slurry 22 from the first tank 20 into the lower portion of the impression in areas adjacent to contaminated soil, and then valve 88 could switch to direct the inert covering slurry, without treatment agent, 82 from second tank 80 to an upper portion of the impression 82, in areas adjacent to non-contaminated soil.

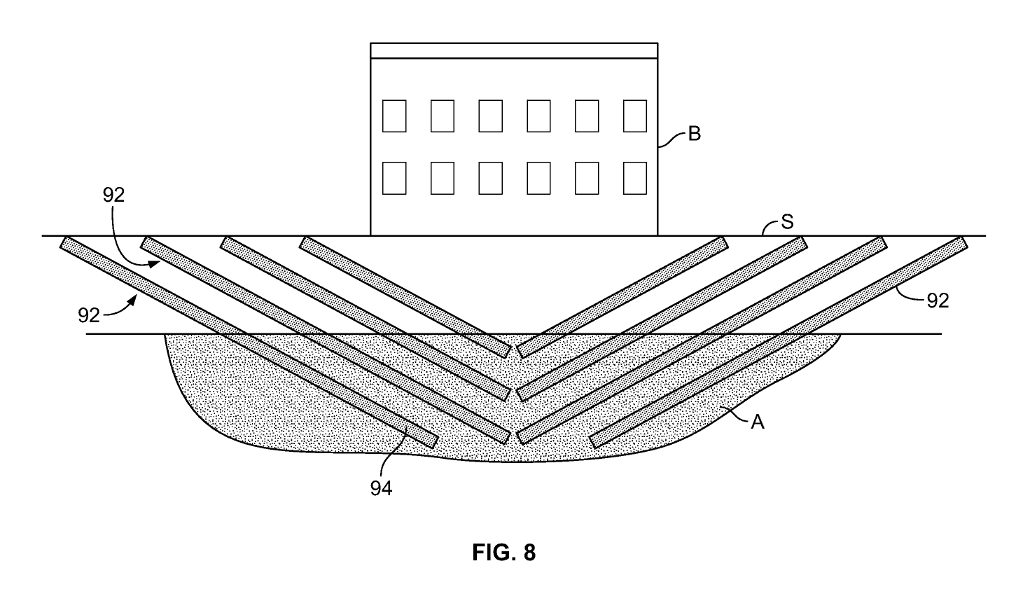

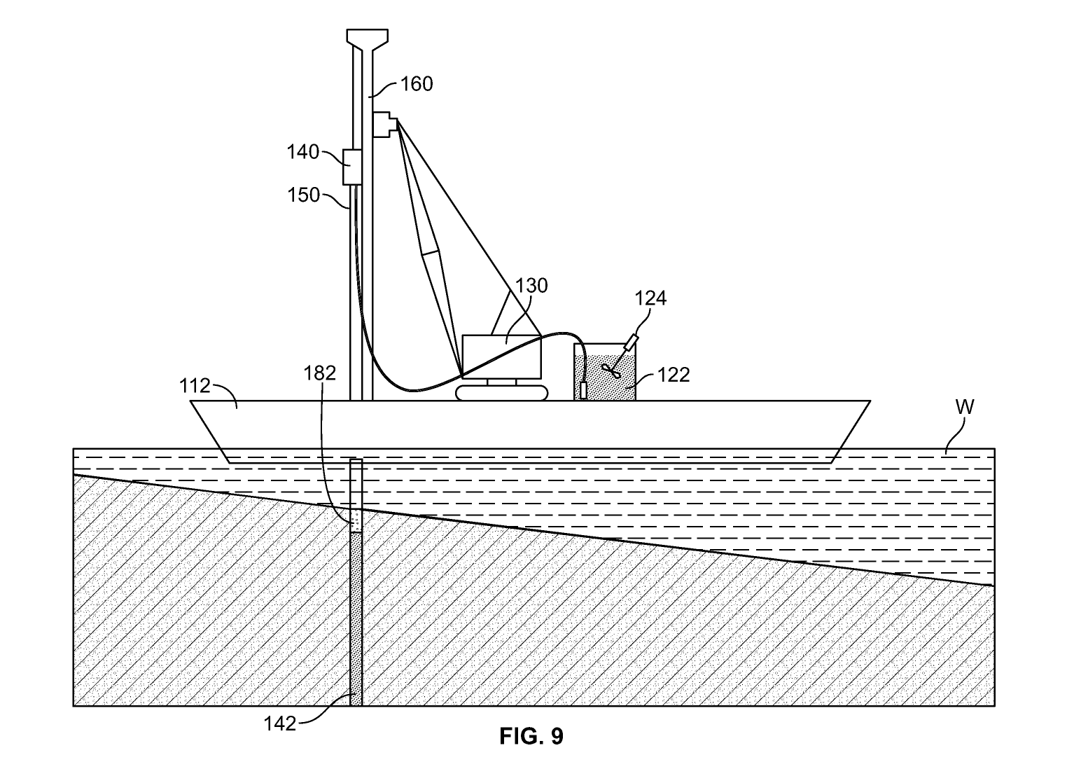

It is also be possible to emplace columns of treatment slurry beneath structures and other surface obstacles using angled placement as shown in FIG. 8. As shown, an area A of soil to be treated is located under building B. Columnar impressions 92 could be made in the soil at angle(s) with respect to the surface S of the soil, and a treatment slurry 94 could be emplaced therein. The angle at which the impressions are formed can vary in accordance with the conditions presented and the limitations of the equipment utilized. Likewise, the length of the impressions can be varied to address the size and position of the area to be treated. Even horizontal placements (not shown) could be feasible using an access trench and rigs capable of pushing or vibrating a rod or beam horizontally.

The apparatus and methods described herein could also be used to treat contaminated sediments by mounting the vibrating beam or other suitable device on a barge, as shown in FIG. 9. The barge 112 carries a tank 120 which holds a treatment slurry 122 and which carries mixer 124. The barge 112 also carries vibrating beam rig 130 which could be affixed to the barge 112 and which drives a vibrating hammer 140. The barge further supports guide beam 160, which could also be attached to the barge 112. The barge could have a port to allow the vibrating beam, such as H-beam 150, or direct push rigs, to operate through the barge 112. In operation, barge 112 is placed in a desired position and H-beam 150 is positioned through the port, into the water, and against sediment under the water. The vibrating beam rig 130 then runs vibration hammer 140 to push the H-beam 150 into the sediment. Once the H-beam 150 reaches the proper depth, it can be removed and the treatment slurry can be pumped into the columnar impression 142 as the H-beam 150 is withdrawn. Thereafter, in accordance with FIG. 7, an inert covering slurry, without treatment agent, 182 from a second tank (not shown), could be placed at an upper portion of the column to minimize contact of the treatment agent with the water.

Having thus described the invention in detail, it is to be understood that the foregoing description is not intended to limit the spirit or scope thereof. What is desired to be protected is set forth in the following claims.

What is claimed is:

1. An apparatus for treating contaminated soil comprising:
a vibrating beam rig;
a vibrating hammer operated by the vibrating beam rig;
a beam vibrated by the vibrating hammer;
a guide beam for guiding the beam into soil as the beam is vibrated by the vibrating hammer to form a columnar impression in the soil;
a treatment slurry; and
a pump and delivery pipe for delivering the treatment slurry into the impression as the beam is withdrawn from the impression.

2. The apparatus of claim 1 wherein the vibrating beam has an H shape in cross-section.

3. The apparatus of claim 1 wherein a pipe runs along the length of the beam for delivering the treatment slurry to the impression.

4. The apparatus of claim 1 further comprising a valve connected to a treatment slurry and an inert covering slurry on one side, and connected to the delivery pipe at another side, the valve switchable to deliver either the treatment slurry or the inert covering slurry to the delivery pipe.

5. The apparatus of claim 1 wherein the vibrating beam rig is mobile.

6. The apparatus of claim 1 wherein the vibrating beam rig is mounted on a barge.

7. The apparatus of claim 6 wherein the barge includes a port for extending the vibrating beam through the barge.

8. The apparatus of claim 1 wherein the treatment slurry comprises a treatment agent mixed with a self-hardening slurry component.

9. The apparatus of claim 8 further comprising a mixer for treatment slurry.

10. A method for treating contaminated soil comprising:
forming a columnar impression in soil using a vibrating beam;
removing the vibrating beam from the soil; and
delivering a treatment slurry into the columnar impression as the vibrating beam is removed from the impression; and
allowing a treatment agent in the treatment slurry to diffuse into the surrounding soil over time.

11. The method of claim 10 wherein the step of forming a columnar impression in soil with the vibrating beam comprises inserting the vibrating beam into soil using a vibrating beam rig and a vibrating hammer.

12. The method of claim 10 wherein the step of delivering the treatment slurry into the columnar impression comprises pumping the treatment slurry into the impression.

13. The method of claim 12 wherein the step of pumping the treatment slurry into the impression comprises pumping the treatment slurry through a channel in the vibrating beam.

14. The method of claim 12 wherein the step of pumping the treatment slurry into the impression comprises pumping the treatment slurry through a delivery tube attached to the vibrating beam.

15. The method of claim 12 further comprising mixing the treatment slurry prior to pumping the treatment agent.

16. The method of claim 10 further comprising delivering an inert covering slurry into the columnar impression after delivery of the treatment slurry into the impression.

17. The method of claim 10 wherein the sediment is under water and the step of forming a columnar impression comprises extending the vibrating beam from a barge, through the water, and into the sediment.

18. A method for treating contaminated soil comprising:
forming a columnar space in the soil;
withdrawing the structural member from the soil;
delivering a treatment slurry into the columnar impression, the treatment slurry including a self-hardening slurry component and a treatment agent;
allowing the treatment slurry to self-harden within the columnar impression; and
allowing the treatment agent in the treatment slurry to diffuse into the soil.

19. The method of claim 18 wherein the step of forming a columnar space comprises inserting a structural member into the soil and then removing the structural member.

20. The method of claim 19 wherein the step of forming a columnar space comprises vibrating a beam into the soil.

21. The method of claim 18 wherein the step of forming a columnar space comprises removing soil.
